(19) United States
(12) Patent Application Publication
(10) Pub. No.: US 2009/0240609 A1
(43) Pub. Date: Sep. 24, 2009

(54) SYSTEM AND METHOD FOR TRACKING AND ANALYZING LOANS INVOLVED IN ASSET-BACKED SECURITIES

(76) Inventors: Soogyung Cho, Corona del Mar, CA (US); Matt R. Schwab, McKinney, TX (US); Kerry Lee Williams, Irvine, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/124,613

(22) Filed: May 21, 2008

Related U.S. Application Data
(60) Provisional application No. 61/037,977, filed on Mar. 19, 2008.

(51) Int. Cl. G06Q 40/00; G06Q 10/00

(52) U.S. Cl. 705/30; 705/38; 705/36 R

(57) ABSTRACT

Embodiments of the disclosure are directed to providing unique loan identifiers to track loans involved in Asset-Backed Securities (ABS) throughout the life-cycle of the individual loans. In one embodiment, a unique loan identifier, for example, a loan number, may be appended to loan data at initiation of each loan, for example, at the application stage, to and/or beyond the retirement of the loan. The unique loan identifiers may allow disparate financial data sources such as the credit histories of the borrowers to be associated with the individual loans, even as the loans are repackaged and resold as ABS in the secondary markets. Thus, market participants such as loan servicers and investors can access current and historical data associated with the loans. Other embodiments are directed to analyzing the data associated with the underlying loans and providing the analysis to the market participants including servicers, investors, and underwriters.

### CROSS-REFERENCE TO RELATED APPLICATIONS

This application is based upon and claims the benefit of priority from U.S. Provisional Patent Application No. 61/037,977 filed on Mar. 19, 2008, entitled “Method and Apparatus for Tracking and Analyzing Loans Involved in Asset-Backed Securities,” the entire contents of which are hereby incorporated herein by reference in their entirety. All publications and patent applications mentioned in this specification are herein incorporated by reference in their entirety to the same extent as if each individual publication or patent application was specifically and individually indicated to be incorporated by reference.

### BACKGROUND

1. Field of the Invention

This disclosure relates in general to computer data processing, and in particular to computer based tracking and analysis of loans and/or assets involved in asset-backed securities.

2. Description of the Related Art

Asset-Backed Securities (ABS) are securitized interests that are based on pools of financial assets. These assets may include mortgages and other receivables such as credit card receivables, auto loans, manufactured-housing contracts, student loans, and home-equity loans. As used herein, the term ABS also encompasses Mortgage-Backed Securities (MBS), Collateralized Debt Obligations (CDO), Collateralized Loan Obligations (CLO), and other similar collateralized or uncollateralized loan-based securities. One goal of securitization of these assets is to make them available for investment to a broader set of investors. However, investors often have little or no access to information relating to the underlying assets and, thus, must rely on credit rating agencies to determine the credit-worthiness of each individual ABS. Such rating systems are not always reliable, and when they fail to predict failures, investors can lose confidence, leading to a loss of flow of capital into the entire ABS market.

### SUMMARY OF THE DISCLOSURE

Embodiments of the disclosure are directed to providing unique loan identifiers to track loans involved in ABS throughout the life-cycle of the individual loans. In one embodiment, a unique loan identifier, for example, a loan number, may be appended to loan data at initiation of each loan, for example, at the application stage, to and/or beyond the retirement of the loan. The unique identifiers may allow disparate financial data sources such as the credit histories of the borrowers to be associated with the individual loans, even as the loans are repackaged and resold as ABS in the secondary markets. Thus, market participants such as loan servicers and investors can access current and historical data associated with the loans. Other embodiments are directed to analyzing the data associated with the underlying loans and providing the analysis to the market participants including servicers, investors, and underwriters.

One embodiment is a computerized system for analyzing loans involved in asset-backed securities. The computerized system comprises a credit migration database that stores consumer credit and financial data; a data repository that assigns a securitization ID to a loan and associates the securitization ID to a credit data record in the credit migration database that is associated with a borrower of the loan and a tracking and analysis module that, upon request, analyzes one or more loans. In this embodiment, the tracking and analysis module uses the respective loan securitization IDs to retrieve the credit data records of the borrowers of the loans from the credit migration database after the loans have been securitized as asset-backed securities, calculate a loan default risk based on payment records and account tradeline information within the credit data records that are associated with the borrowers, and store the loan default risk in the data repository. The computerized system may also include a portal interface through which authorized users can access at least the loan default risk stored in the data repository, wherein the portal interface is configured to provide data to the authorized users via one or more network connections.

Another embodiment is a method of analyzing performance of loans and borrower credit profiles involved in asset-backed securities, comprising assigning a unique loan identifier to each of a plurality of loans; associating one or more borrower credit data records with each of the loan identifiers; after the loans have been issued and securitized as asset-backed securities, using the loan identifiers to retrieve the credit data records of the respective borrowers of the plurality of loans; and analyzing the loans based on the retrieved credit data records of the borrowers.

Another embodiment is a computerized system for analyzing loans involved in asset-backed securities, comprising: a data repository that assigns a unique loan identifier to each of a plurality of loans and associates each loan identifier to one or more credit data records of the respective borrowers of the loans; and a tracking and analysis module that, upon request, analyzes a first plurality of the loans that have been combined into an asset-backed security, wherein the tracking and analysis module uses the loan identifiers associated with the first plurality of loans in order to: retrieve credit data records of the borrowers associated with the first plurality of loans after the loans have been securitized as asset-backed securities, analyze the performance of the first plurality of loans based on the retrieved credit data records, and provide the performance analysis to one or more entities that are authorized to receive the performance analysis.

Another embodiment is a computer program product comprising a computer usable medium having control logic stored therein for causing a computer to track and analyze loans involved in asset-backed securities, comprising: a first computer readable program code means for causing the computer to assign a unique loan identifier to each of a plurality of loans; a second computer readable program code means for causing the computer to associate one or more borrower credit data records with each of the loan identifiers; a third computer readable program code means for causing the computer to use the loan identifiers to retrieve the credit data records of the respective borrowers of the plurality of loans after the loans have been issued and securitized as asset-backed securities; and a fourth computer readable program code means for causing the computer to analyze the loans based on the retrieved credit data records of the borrowers.

### BRIEF DESCRIPTION OF THE DRAWINGS

Specific embodiments of the invention will now be described with reference to the following drawings, which are intended to illustrate embodiments of the invention, but not limit the invention:

FIG. 1 is a block diagram illustrating one embodiment of a loan tracking and analysis system;

FIG. 2 is a flow diagram illustrating an overview of the system and method according to one embodiment;

FIG. 3 is a flow diagram illustrating one embodiment of a method for loan tracking;

FIG. 4A is a block diagram illustrating one embodiment of a system and method for ABS tracking and analysis;

FIG. 4B is a block diagram illustrating one embodiment of a system and method for loan identifier assignment;

FIG. 4C is a block diagram illustrating an example data structure for tracking and analyzing loans involved in ABS;

FIG. 4D is a flow diagram illustrating one embodiment of a method of tracking and analyzing loans involved in ABS;

FIG. 5 is a block diagram illustrating data sources used in the system in accordance with one embodiment;

FIG. 6A is a block diagram illustrating one embodiment of a system and method for processing credit data migration into the loan tracking and analysis system;

FIGS. 6B-1 to 6B-4 show sample outputs from the process of credit data migration;

FIG. 7A is a block diagram illustrating one embodiment of a system and method for defining and sending trigger-based notifications;

FIG. 7B illustrates sample triggers according to an embodiment;

FIG. 8 shows a portal interface embodiment that is usable to access certain ABS analytics data;

FIGS. 9-1 to 9-4 show example outputs of the portfolio management interface according to an embodiment;

FIG. 10 illustrates the loan level detail provided by the loan management scorecard interface according to an embodiment;

FIGS. 11A and 11B show a sample view of the dashboard interface according to an embodiment; and

FIG. 12 shows a sample output of a geographical portfolio analysis according to one embodiment.

### DETAILED DESCRIPTION OF THE PREFERRED EMBODIMENT

Preferred embodiments will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments. Furthermore, embodiments may include several novel features, no single one of which is solely responsible for its desirable attributes or which is essential to practicing the inventions herein described.

System Implementation

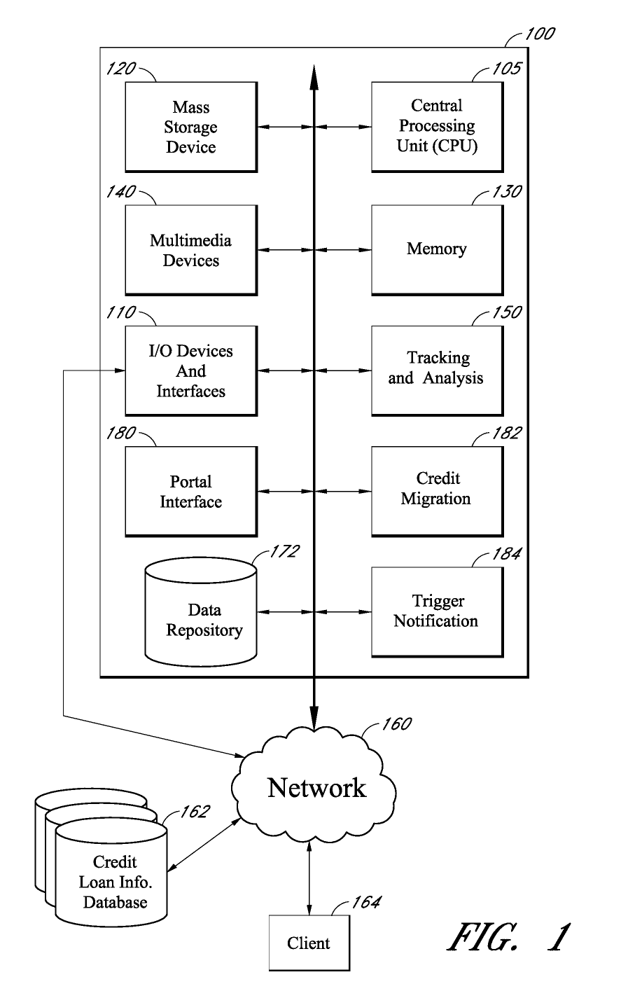

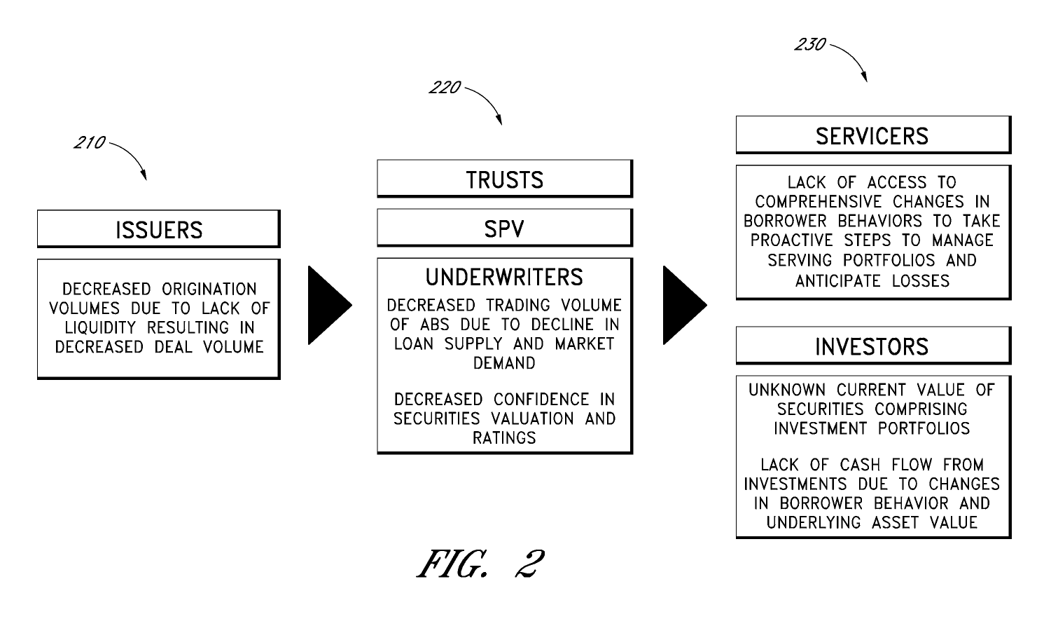

FIG. 1 is a block diagram showing an embodiment in which a loan tracking and analysis system 100 is in communication with a network 160 and various systems are also in communication with the network 160. The loan tracking and analysis system 100 may be used to implement certain systems and methods described herein. For example, the loan tracking and analysis system 100 may be configured to receive financial and demographic information regarding individuals and generate reports and/or alerts for one or more clients. Although the description provided herein refers to individuals, consumers, or customers, the terms “individual,” “consumer,” “borrower,” and “customer” should be interpreted to include applicants, or groups of individuals or customers or applicants, such as, for example, married couples or domestic partners, organizations, groups, and business entities.

The loan tracking and analysis system 100 includes, for example, a personal computer that is IBM, Macintosh, or Linux/Unix compatible. In one embodiment, the loan tracking and analysis system 100 comprises a server, a laptop computer, a cell phone, a personal digital assistant, a kiosk, a mobile device, a Blackberry, or an audio player, for example. In one embodiment, the sample loan tracking and analysis system 100 includes a central processing unit (“CPU”) 105, which may include a conventional microprocessor. The loan tracking and analysis system 100 further includes a memory 130, such as random access memory (“RAM”) for temporary storage of information and a read only memory (“ROM”) for permanent storage of information, and a mass storage device 120, such as a hard drive, diskette, or optical media storage device. Typically, the modules of the loan tracking and analysis system 100 are connected to the computer using a standard based bus system. In different embodiments, the standard based bus system could be Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of loan tracking and analysis system 100 may be combined into fewer components and modules or further separated into additional components and modules.

The loan tracking and analysis system 100 is generally controlled and coordinated by operating system software, such as Windows Server, Linux Server, Windows 98, Windows NT, Windows 2000, Windows XP, Windows Vista, Unix, Linux, SunOS, Solaris, or other compatible server or desktop operating systems. In Macintosh systems, the operating system may be any available operating system, such as MAC OS X. In other embodiments, the loan tracking and analysis system 100 may be controlled by a proprietary operating system. Conventional operating systems control and schedule computer processes for execution, perform memory management, provide file system, networking, I/O services, and provide a user interface, such as a graphical user interface (“GUI”), among other things.

The sample loan tracking and analysis system 100 includes one or more commonly available input/output (I/O) devices and interfaces 110, such as a keyboard, mouse, touchpad, and printer. In one embodiment, the I/O devices and interfaces 110 include one or more display device, such as a monitor, that allows the visual presentation of data to a user. More particularly, a display device provides for the presentation of GUIs, application software data, and multimedia presentations, for example. The loan tracking and analysis system 100 may also include one or more multimedia devices 140, such as speakers, video cards, graphics accelerators, and microphones, for example. In other embodiments, such as when the loan tracking and analysis system 100 comprises a network server, for example, the computing system may not include any of the above-noted man-machine I/O devices.

In the embodiment of FIG. 1, the I/O devices and interfaces 110 provide a communication interface to various external devices. In the embodiment of FIG. 1, the loan tracking and analysis system 100 is electronically coupled to a network 160, which comprises one or more of a LAN, WAN, or the Internet, for example, via a wired, wireless, or combination of wired and wireless, communication link 115. The network 160 facilitates communications between various computing devices and/or other electronic devices via wired or wireless communication links.

According to FIG. 1, information is provided to the loan tracking and analysis system 100 over the network 160 from one or more data sources including, for example, credit and/or loan information databases 162. The information supplied by the various data sources may include credit data, demographic data, loan data, loan application information, product terms, accounts receivable data, and financial statements, for example. In addition to the devices that are illustrated in FIG. 1, the loan tracking and analysis system 100 may communicate with other data sources or other computing devices. In addition, the data sources may include one or more internal and/or external data sources. In one embodiment, the loan tracking and analysis system 100 includes a credit migration module 182 that retrieves credit data from at least one of the databases 162. In some embodiments, one or more of the databases, data repositories, or data sources may be implemented using a relational database, such as Sybase, Oracle, CodeBase and Microsoft® SQL Server as well as other types of databases such as, for example, a flat file database, an entity-relationship database, and object-oriented database, and/or a record-based database.

A client 164 may access the loan tracking and analysis system 100 through the network 160. The client 164 may include a desktop or laptop computer, a computer server, a mobile computing device, a Blackberry, or other similar electronic device. In addition to supplying data, client 164 may further request information from the loan tracking and analysis system 100. For example, the client 164 may request data related to a borrower or a group of borrowers, or data related to a loan or a group of loans. Such a request may include borrower/loan information identifying the borrower(s)/loan(s) for which information is desired.

In the embodiment of FIG. 1, the loan tracking and analysis system also comprises a data repository 172. In other embodiments, the system 100 communicates with the data repository 172 through a network, such as a LAN, WAN, or the Internet via a wired, wireless, or combination of wired and wireless, communication link. In certain embodiments, the client 164 may have access to the data repository 172 through the network 160, and/or other network.

In the embodiment of FIG. 1, the loan tracking and analysis system 100 also includes a tracking and analysis module 150 that may be executed by the CPU 105. This module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In the embodiment shown in FIG. 1, the loan tracking and analysis system 100 is configured to execute the tracking and analysis module 150, among others, in order to track and analyze loans involved in ABS by using data in the data repository 172, credit and/or loan information databases 162, and/or other data sources that comprises data regarding ABS. These records may be accessed by the tracking and analysis module 150 to track and analyze loans, as will be described in more detail below. The loan tracking and analysis system 100 may also include a portal interface 180, which is configured to generate one or more graphical user interfaces (“GUIs”) through which loans can be tracked and analyzed. The portal interface 180 may provide access to loan analysis results and reports generated by the tracking and analysis module 150. Finally, the loan tracking and analysis system 100 may also include a trigger notification module 184, which sends notifications to users of the system when credit data sources associated with the loans involved in ABS meet certain user-defined condition triggers.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

Asset-Backed Securities (ABS) Tracking and Analysis

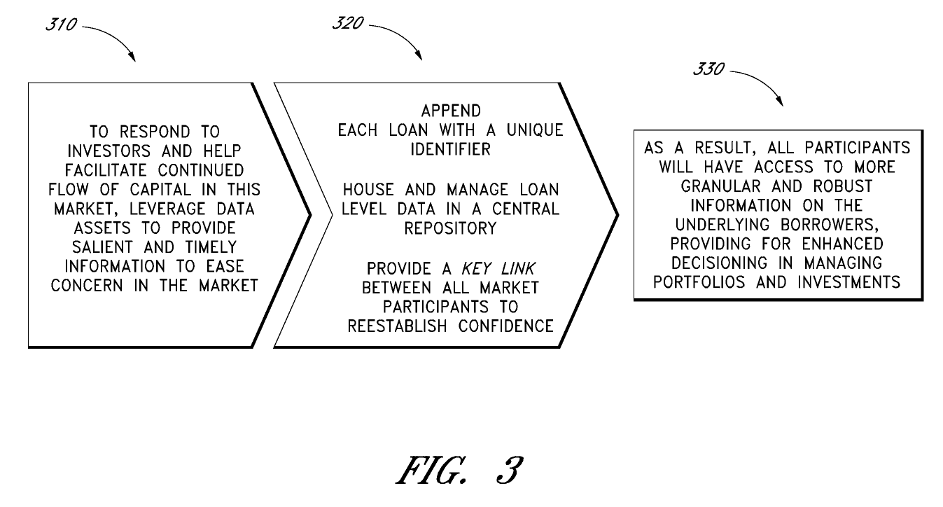

FIG. 2 provides an overview of the method and system in accordance with one embodiment. At block 210, loan issuers issue loans backed by a variety of assets including, for example, real estate and automobiles. The issuers then forward the loans to underwriters, Special Purpose Vehicles (SPV), or Trusts at block 220, and the underwriters bundle the loans into asset-backed securities (ABS). In the bundling process, the underwriters also evaluate the strength of the ABS, work with rating agencies to rate them, and associate them with various rates of return. The ABS are then presented to investors for investment at block 230.

In some embodiments, the loan tracking and analysis system 100 is configured to reduce problems in the way ABS are constructed and presented to investors. Often at block 230, investors do not know the current value of the ABS they are holding, and have no access to the credit profiles of the individual borrowers that underlie the securities. Sometimes the only piece of credit information available is a credit score obtained at the time of loan origination. Servicers are limited to the performance of the loan that they are serving and do not have access or insight into the comprehensive profile of the borrowers' credit behavior. Changes in borrower behavior and underlying assets are not captured over time.

The lack of transparency becomes exposed in actual market failures. As a result, investors may lose confidence in the rating and valuation generated by the underwriters at block 220. This may lead to a decreased level of investment, which in turns leads to decreased liquidity in the market. As shown in FIG. 2, decreased liquidity may lead to decreased loan origination volume at block 210. The decreased origination volume in turn may lead to decreased trading volume of ABS at block 220.

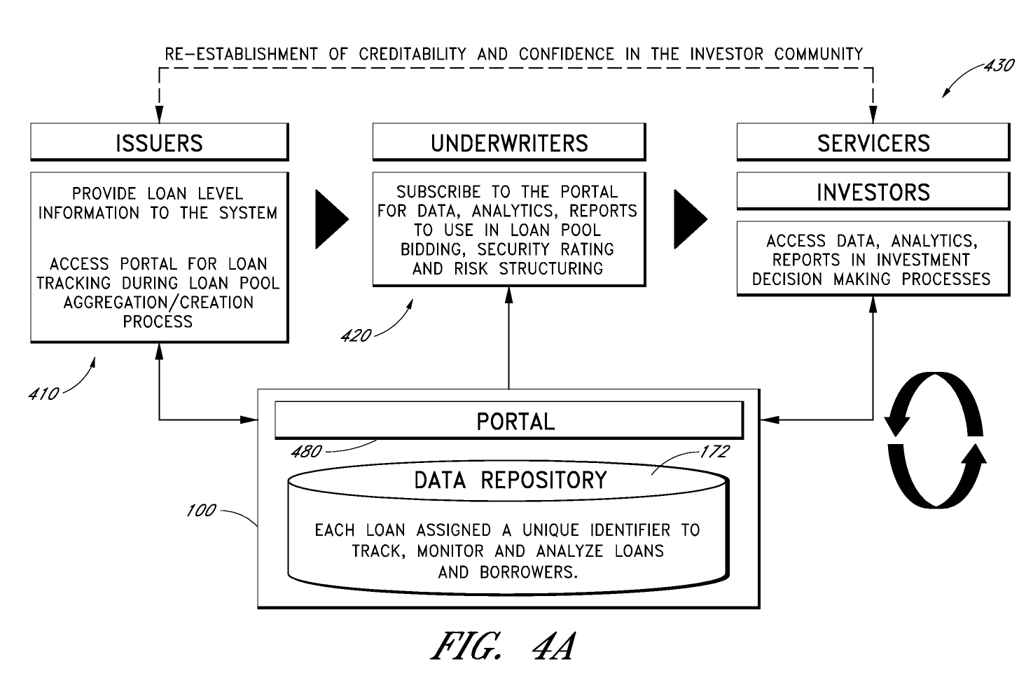

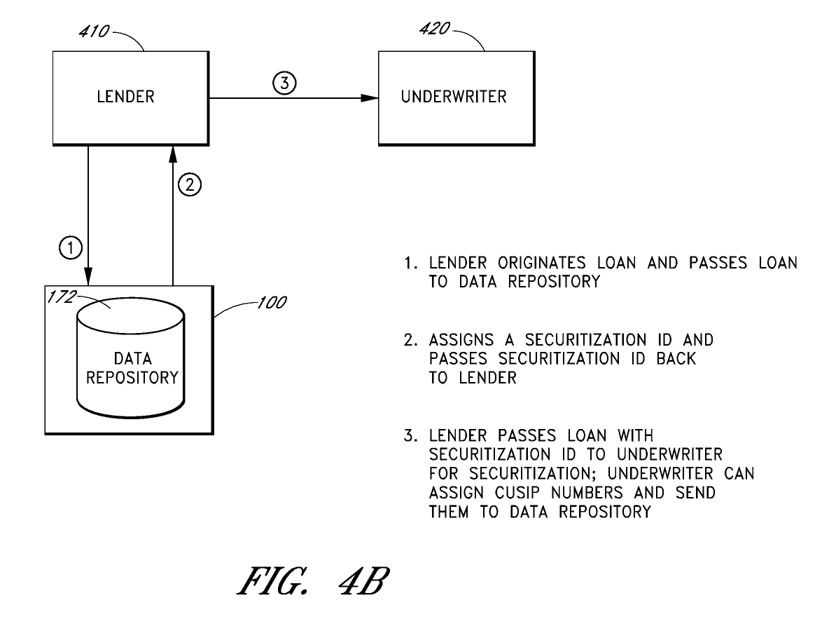

FIG. 3 provides an overview of a tracking method in accordance with one embodiment. In response to the loss of confidence in the ABS capital markets, embodiments of the systems and methods described herein are directed to increase transparency by providing a link among the market participants—loan originators/issuers, investment banks, trusts, servicers, and investors. To this end, in some embodiments the loan tracking and analysis system 100 appends unique loan identifiers to data records for individual loans, allowing the market participants to track each loan through its lifecycle, both at its origination (the primary market) and when it is later securitized and resold as part of an investment (the secondary market). In one embodiment, the loan tracking and analysis system 100 tracks, monitors, and analyzes each pool or portfolio of loans and hosts loan level data in the data repository 172. An example portfolio could be a service portfolio belonging to a loan servicer that services student or auto loans or an investment portfolio that belongs to an investment bank. In essence, the loan tracking and analysis system 100 may function as a credit file for the capital markets.

As shown in FIG. 3, the loan tracking and analysis system 100 may be configured to correct this loss of confidence and help facilitate the continued flow of capital into this market by leveraging available credit and financial data assets to provide salient and timely information to ease concern in the market (block 310). In certain embodiments, the loan tracking and analysis system 100 may append each loan record with a unique loan identifier, house and manage loan level data in a central data repository (for example, in the data repository 172), and through the use of unique loan identifiers, provide a key link between market participants involved in the ABS process (block 310). These unique loan identifiers may be used to provide participants in the securitization market with additional information that may reestablish confidence in the ABS market. As a result, all participants may be provided access to more granular and robust information on the underlying assets, providing for enhanced decision-making in managing portfolios and investments (block 310).

Loan Tracking and Analysis Process and System

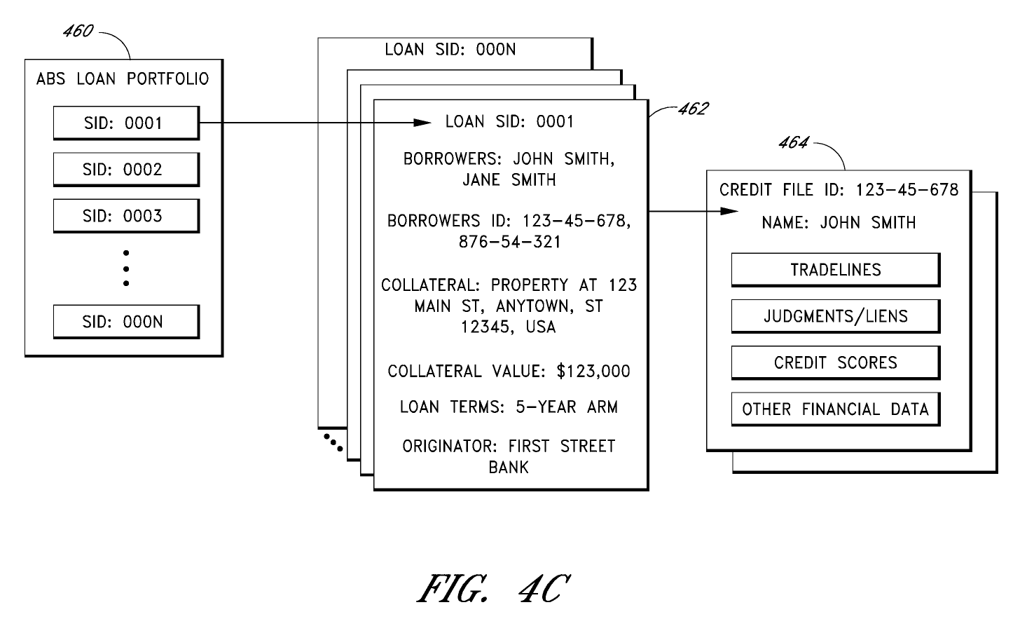

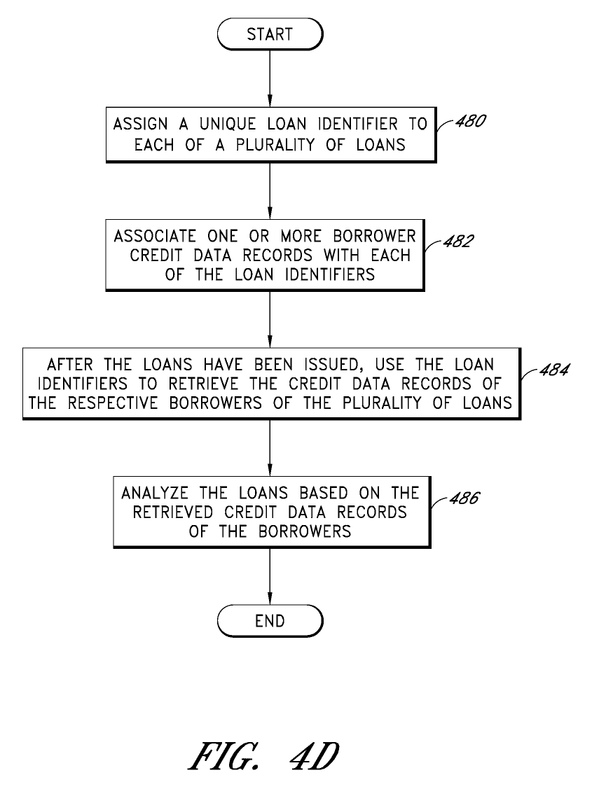

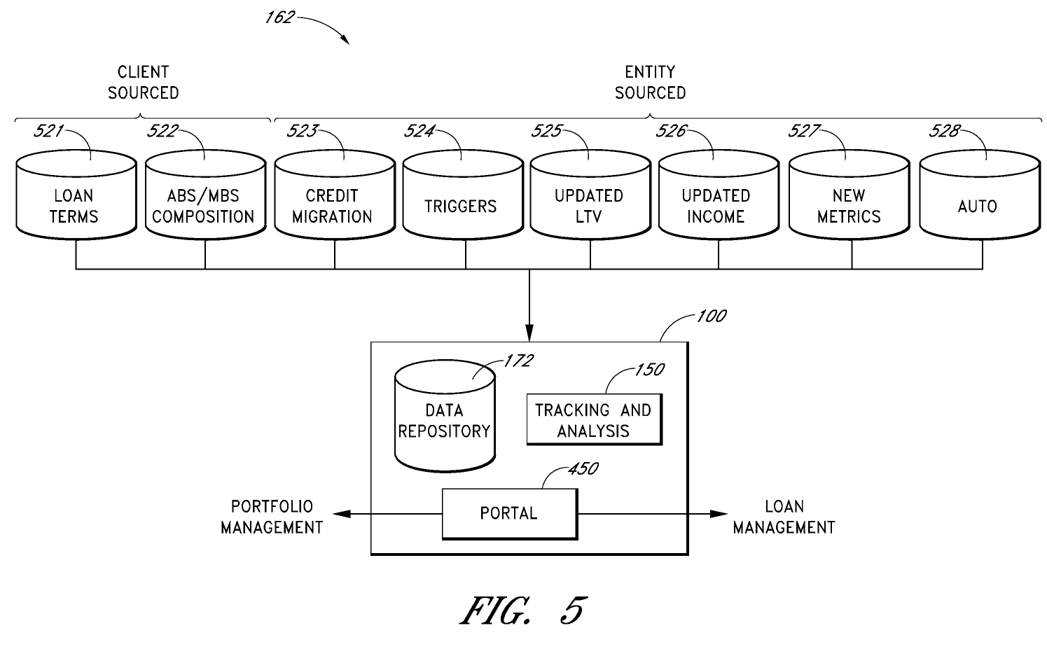

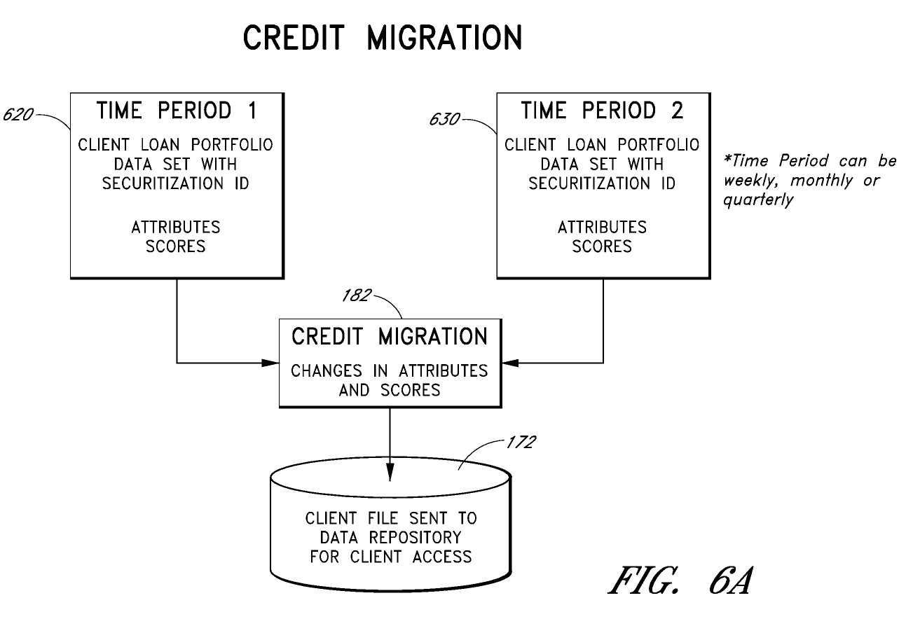

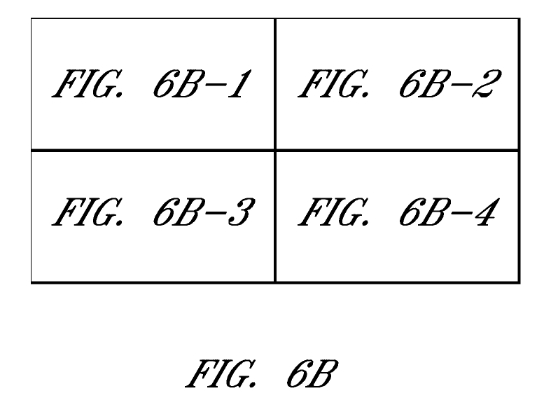

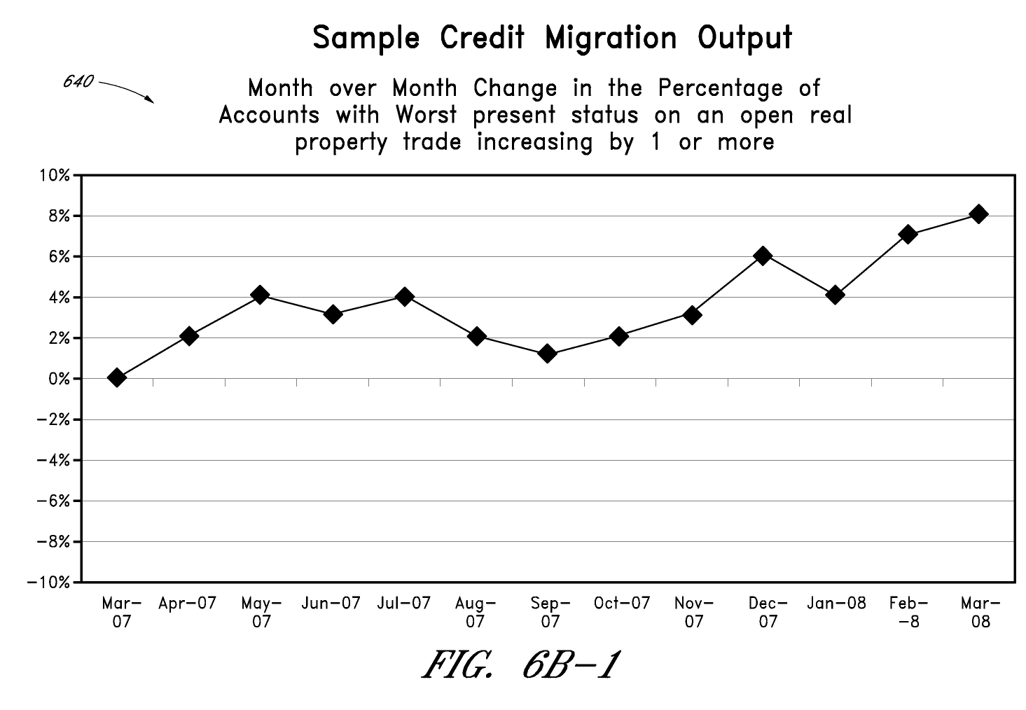

FIG. 4A is a diagram depicting a system and method in accordance with one embodiment. At block 410, an issuer provides loan data to the data repository 172 of the loan tracking and analysis system 100, and the system 100 appends a unique loan identifier, also referred to as a securitization ID in one embodiment, to the loan data and may return the unique loan identifier to the issuer. The unique identifier can include a social security ID number, a tracking number, a bar code or grid, and/or any other any alpha-numeric identifier. In one embodiment, the loan tracking and analysis system 100 may be operated by a credit bureau. Optionally, the unique loan identifier can be automatically appended to loan data when an issuer reports the loan to the loan tracking and analysis system 100. Once the unique loan identifier has been appended, the issuer or any other authorized party can access the portal interface 180 to track the loan's progress and/or report updates. In addition, the portal interface 180 can be used to track a plurality of loans during an aggregation process in which loans are grouped together for the purpose of securitization. In contrast to the internal loan tracking numbers assigned by the issuers that are not passed to underwriters and investors, the unique loan identifiers may be maintained throughout and/or beyond the life of the loans. The unique loan identifiers may enable underwriters, investors, and others, to access historical as well as updated loan data associated with specific loans, as well as credit and payment behavior data of borrowers associated with the loans.

At block 420, underwriters can use the portal interface 180 to access loan data, analytics, and reports. Such information can be used in loan pool bidding, security rating, and risk structuring. Underwriters may also send loan identifiers and corresponding security identifiers, for example, CUSIP (Committee on Uniform Security Identification Procedures) numbers, to the loan tracking and analysis system 100 during the securitization process and the loan tracking and analysis system 100 may associate the loan identifiers with the proper security identifiers. At block 430, investors can also access data, analytics, and reports for all the loans in their ABS investments through the portal interface 180. This access to loan level data may enhance their investing decisions because investors can verify updated conditions of the underlying assets and financial conditions of the borrowers. Similarly, loan servicers may also access the same type of analytical data for loans in their service portfolios via the portal interface 180. For example, student loan servicers may access the credit scores of the students within their loan pools to better gauge default risks or anticipate losses. Market participants may also need to access such data and analytics in compliance with governmental regulations that mandate periodic financial disclosure and reporting. Portfolios may be accessed by supplying the loan tracking and analysis system 100 the CUSIP numbers. Other interested parties such as governmental regulatory bodies may access these loan data through the portal interface 180 as well.

Generally speaking, a credit enhancement is a method to reduce risk by providing some insurance or guarantee agreements to reimburse investors in the event of a loss. Because the disclosed embodiments provide, through portal interface 180, additional updated loan and borrower data to investors that were previously inaccessible, the disclosed embodiments also reduce risks of loss and thus can be used as credit enhancements to create a security that has a higher rating than the issuing company that monetizes its assets. This may allow the issuer to pay a lower rate of interest than would be possible via a secured bank loan or debt issuance.

Loan Identifier Assignment and Data Structure

FIG. 4B shows a loan identifier assignment method in accordance with one embodiment. In this embodiment, a lender 410 originates a loan and passes associated loan data to the loan tracking and analysis system 100. Then the loan tracking and analysis system 100 determines and assigns a securitization ID to the loan and passes the securitization ID back to the lender. The loan tracking and analysis system 100 may store the loan information along with the securitization ID so that other authorized market participants may access the loan information in the future with the securitization ID. Next, upon the issuance of the loan, the lender 410 passes the loan along with the securitization ID to the underwriter or Special Purpose Vehicle (SPV) 420 for securitization. Once the securitization process is completed, the Underwriter or SPV may send the CUSIP number for the newly created security to the loan tracking and analysis system 100. In one embodiment, the CUSIP numbers may be stored in the data repository 172 and may be used to retrieve corresponding credit and financial data for analyzing the performance of the securities.

FIG. 4C shows an example data structure in accordance with one embodiment. As shown, an example ABS loan portfolio 460 may bundle many loans. In accordance with the system and method depicted in FIG. 4A, each loan is associated with a unique identifier that is created and associated with the loan at the point when the loan is first issued (e.g., block 410 in FIG. 4A). In the embodiment shown, a Securitization ID (SID) is used as the unique identifier, and as shown, a SID 0001 is associated with a loan record 462 comprising data associated with a particular loan. In one embodiment, the loan record 462 may include various details associated with one or more loans, including the information on the borrowers and the collateral, loan terms, and other loan-related data.

In particular, the loan record 462 may include an identifier that identifies the borrowers of the loan. The borrower identifier may include a social security number, a taxpayer ID number, an internal database linking identifier, and/or any other identifier that links the loan record to the borrower's financial data/credit data file. As shown in FIG. 4B, borrower credit data record 464 is linked to the SID 0001 by way of a borrower ID “123-45-678.” In one embodiment, the credit data record may be a unique PIN-based consumer credit data record. The borrower's credit data record 464 may contain tradelines, judgments and liens, credit scores, and other financial data regarding a particular individual, or group of related individuals. As such, a SID may be used to cross-reference one or more associated borrower identifiers and access the credit-record(s)/file(s) of the borrower(s) of the loans underlying the ABS. Interested parties, such as ABS investors, may therefore assess and monitor factors that may affect the borrowers' ability to repay the loans. In other embodiments, loan records are not stored in the loan tracking and analysis system 100. Rather, the loan tracking and analysis system 100 stores a database table pairing unique loan identifiers with corresponding borrower identifiers. The pairing allows the borrowers' financial and credit data to be accessed by using the unique loan identifiers.

FIG. 4D shows a tracking and analysis method in accordance with one embodiment. At block 480, a unique loan identifier is assigned to each of a plurality of loans. Then at block 482, one or more borrower credit data records are associated with each of the loan identifiers. After the loans have been issued and securitized as asset-backed securities, possibly being transferred between multiple portfolios, at block 484 the loan identifiers are used to retrieve the credit data records of the respective borrowers of the plurality of loans. The loans may be assigned to loan portfolios and each portfolio may be assigned a security number (for example, a CUSIP number). Thus, the loan tracking and analysis system 100 may be able to access the credit data records by cross-referencing the loan identifiers associated with a security number. For example, the loan tracking and analysis system 100 may be able to retrieve credit data records for borrowers of a loan portfolio given the portfolio's CUSIP number. Finally, at block 486, loan details may be analyzed based on the retrieved credit data records of the borrowers.

Data Sources for ABS Analysis

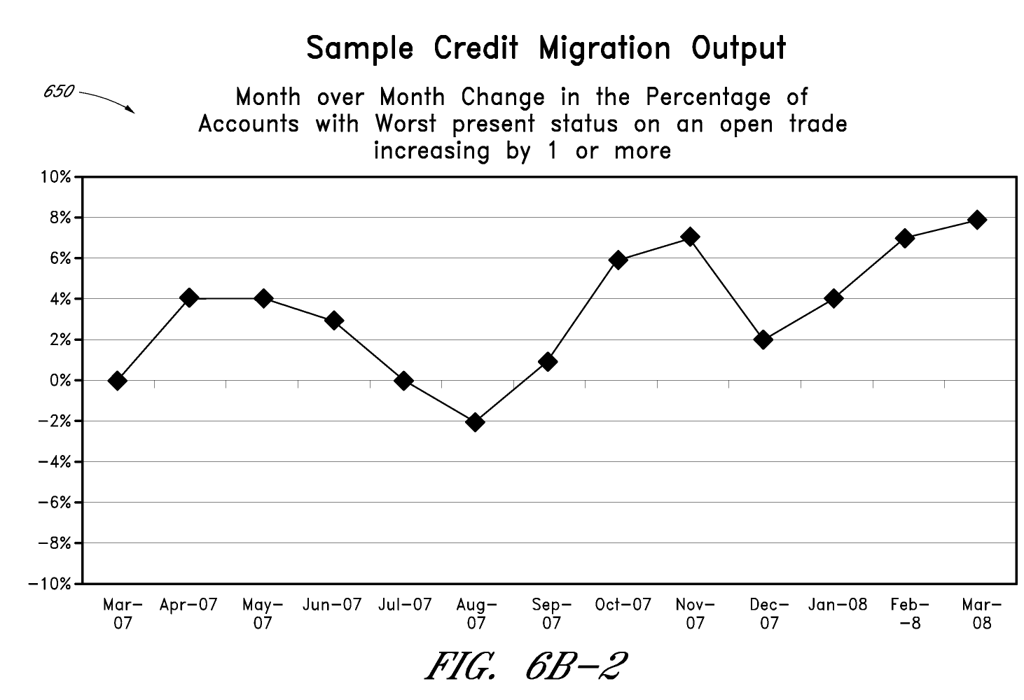

FIG. 5 depicts one embodiment of the system 100 in communication with a plurality of credit and/or loan information databases 162, specifically noted in FIG. 5 as data sources 521-528. The loan tracking and analysis system 100 as illustrated in FIG. 5 includes only a few of the modules that are available in embodiments of the system 100 (see FIG. 1, for example). In particular, the system 100 of FIG. 5 includes the tracking and analysis module 150, the portal interface 180, and the data repository 172, which may include data from a variety of data sources. In one embodiment, data is sourced from a loan terms database 521 and/or an ABS/MBS composition database 522. These two databases may reside at the issuer, the underwriter, or elsewhere. Data may also be sourced from a credit migration database 523, a triggers database 524, an updated Loan to Value (LTV) database 525, an updated income database 526, a new metrics database 527, an auto loan data database 528, and any number of additional databases.

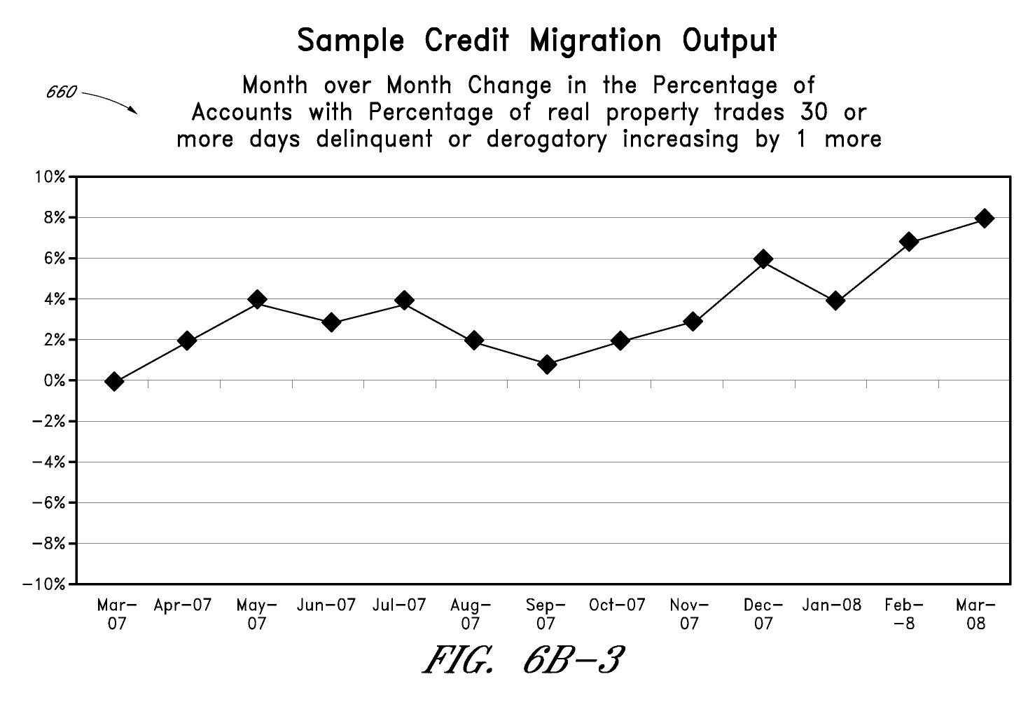

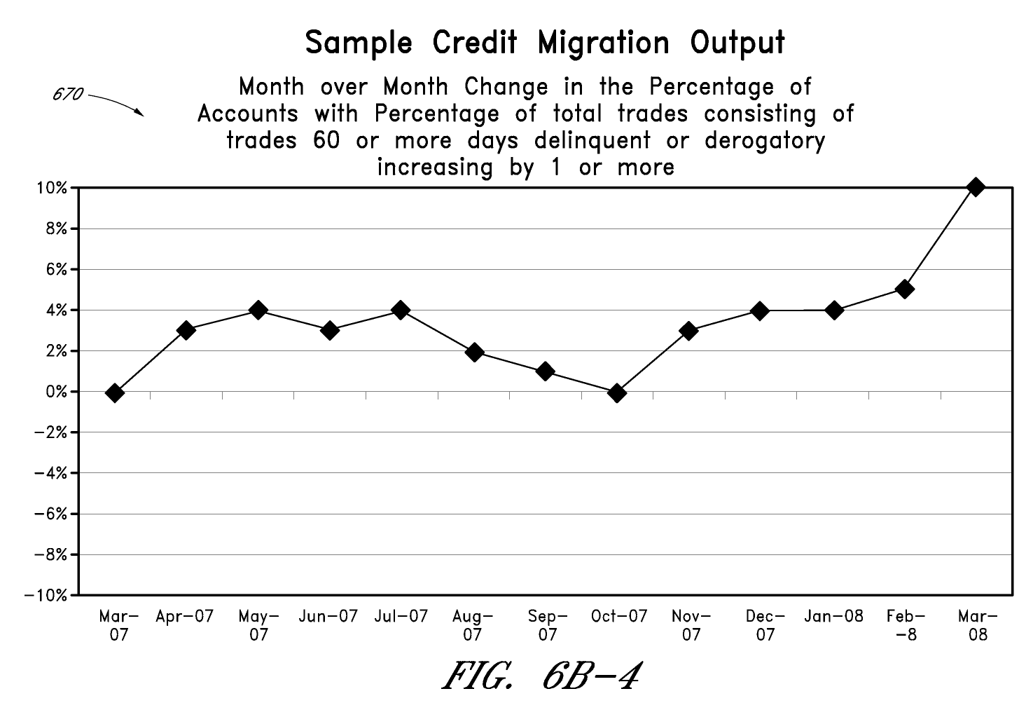

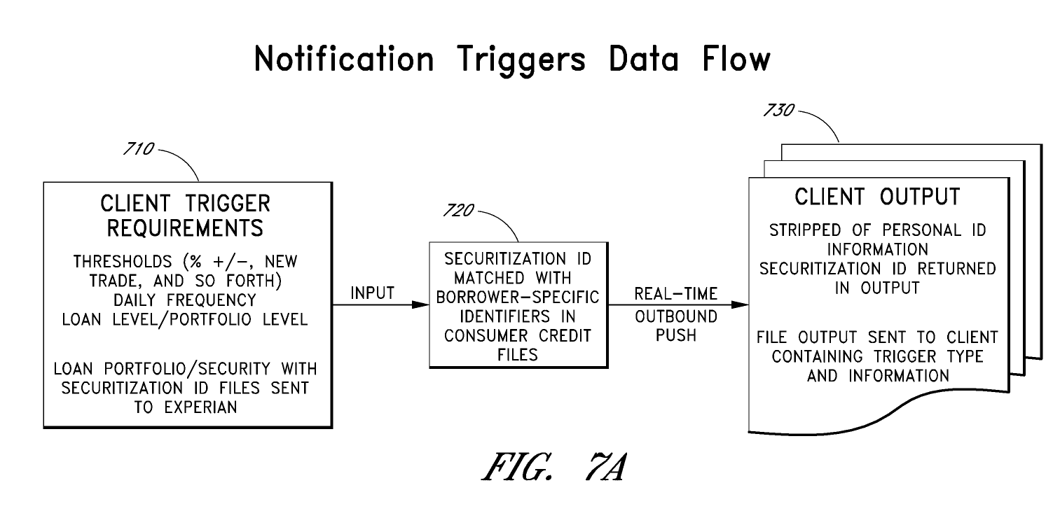

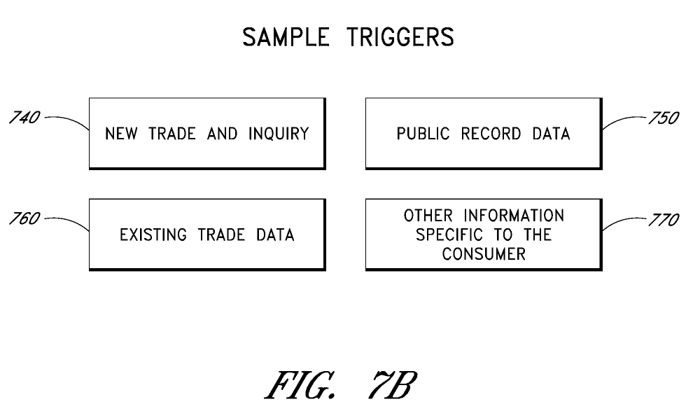

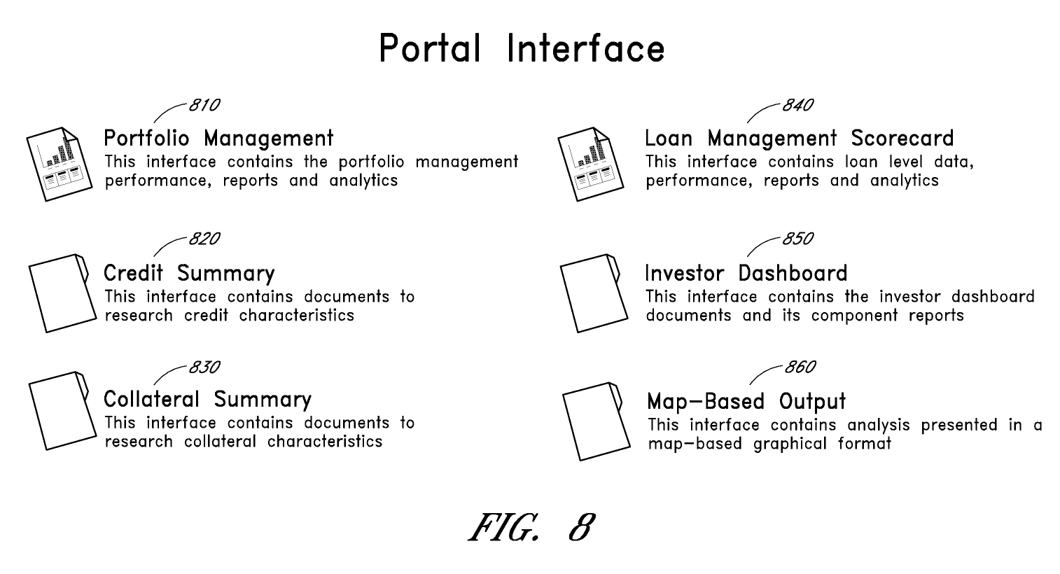

The credit migration database 523 may provide the loan borrowers' credit data and credit histories. The credit migration database 523 and its use will be further described in conjunction with FIGS. 6A and 6B. The triggers database 524 may provide pre-defined conditions that may trigger alerts to the users if those conditions are met. Likewise, the triggers database 524 and its use will be further described in conjunction with FIGS. 7A and 7B.

The updated LTV database 525 may store continuously or periodically updated information on loan values, underlying asset values, and the ratios of loan values to asset values. In one embodiment, the asset valuation information may be obtained from a source outside of the entity hosting the loan tracking and analysis system 100. The updated income database 526 may provide updated data on the borrowers' current income. The income information may be obtained from an outside source or may be estimated based on data collected by the hosting entity. The new metrics database 526 may provide additional metrics, such as custom-defined credit attributes and credit scores, that may aid in the analysis of the ABS. The new metrics database 526 may include, for example, special monitoring conditions or analytic instructions submitted by investors or loan servicers that are particular to their ABS or loan portfolios. Finally, the auto loan database 528 may include additional loan details related to automobile loans. These six databases may reside within the same entity that is hosting the loan tracking and analysis system 100. Those skilled in the art will recognize that these databases can be combined into fewer databases, or may be implemented as parts of a single database. Conversely, they may be divided into a greater number of databases. Finally, these databases as shown may be implemented as a combination of parts within the same databases and separate databases.

The loan tracking and analysis system 100 may further include the tracking and analysis module 150 for processing data and outputting results. In one embodiment, the results of the analysis are accessible via the portal interface 180. The portal interface 180 may be configured to accept requests from a variety of devices, including but not limited to computer servers, personal computers, laptop computers, kiosks, and mobile devices such as phones, PDAs, and Blackberries, and output results in one or more GUIs to those devices.

Two mechanisms by which the loan tracking and analysis system 100 retrieves and analyzes loan data—credit migration and triggers—will be further described below.

Credit Migration

One problem ABS investors face is the inability to retrieve up-to-date analysis of the loans underlying the ABS. Often ABS issuers provide only analysis obtained at the point of loan origination or ABS generation but little else after the sale of the ABS. The credit migration mechanism in one embodiment addresses this need and provides up-to-date analysis to investors and other market participants.

FIG. 6A shows the credit migration module 182 of the system 100 (FIG. 1) that periodically retrieves data for a plurality of client loan portfolio data sets with their associated securitization IDs. The client here may be, for example, an investment bank that wishes to monitor the performance of a particular investment portfolio, a loan servicer that wishes to monitor the creditworthiness of the borrowers that are in its loan service portfolio, or any other interested party. These clients may send to the loan tracking and analysis system 100 information regarding loan portfolios, including the associated securitization IDs. Alternatively, the loan tracking and analysis system 100 may keep track of the loans that are associated with each client's portfolio(s).

In one embodiment, the credit migration module 182 is configured to retrieve, at specified time intervals, credit attributes, scores, and other credit-related data of the borrowers of the loans referenced by the securitization IDs. In one embodiment, the credit data is retrieved in accordance with the lookup and cross-referencing method depicted in FIG. 4C. In the example shown, a data set 620 from a time period 1 and a data 630 set from a time period 2 are retrieved by the credit migration module 182 for comparison. The time period can be weekly, monthly, quarterly, or any other frequency. In one embodiment, the credit migration module 182 migrates the necessary data from a credit database into the data repository 172 of the loan tracking and analysis system 100 at specified time intervals. Co-pending U.S. patent application Ser. No. 11/973,300, filed Oct. 5, 2007, entitled “System and Method for Generating a Finance Attribute From Tradeline Data,” the disclosure of which is hereby entirely incorporated by reference, further describes various embodiments of credit data attributes. The credit data attributes may include collateral value attributes in one embodiment.

Once the credit data are retrieved, the credit migration module 182 and/or the tracking and analysis module 150 calculates or determines changes in attributes, scores or other credit data. For example, the credit migration module 182 and/or the tracking and analysis module 150 may calculate the change in average credit scores of the borrowers in the portfolio data set, determine whether these borrowers have opened new lines of credit, or determine whether negative credit items have been added to their credit files, and so forth. These changes and/or the retrieved credit data may then be migrated to the data repository 172. Over time, the data repository 172 may accumulate a history of the credit and analysis data, such as over the life of the ABS loan portfolios, and can output these historical data.

FIG. 6B shows four sample outputs, such as graphical user interfaces that are displayed on a computer monitor or in printed form, of the credit migration module in accordance with one embodiment. These outputs may be in a raw data format, a table/spreadsheet format, or in a graph format as shown and they may depict historical trends or comparison of data obtained from different specified intervals. The trends may include payment behavioral changes, credit behavioral changes, and projection of future performances.

FIG. 6B-1 shows an example output graph 640, which plots monthly changes in the percentage of loan accounts in a portfolio having a worst present status on an open real property trade increasing by 1 or more. In general, a worst present status in an individual's credit history indicates a negative status on a tradeline account. In one embodiment, an increase in the number of worst present statuses on open real property trades (for example, mortgage) could be indicative of an increased default risk, and tracking this attribute over time can reveal the default risk associated with a loan portfolio. To illustrate this attribute, take for example a borrower A whose credit file lists multiple accounts such as credit cards, student loans, car loans, and several mortgages including home equity lines of credit. In the embodiment of FIG. 6B-1, a worst present status attribute that indicates whether borrower A has incurred a new worst present status in any of his mortgages (open real property tradelines) over the last month (that is, increasing by 1 or more) is shown. Therefore, if borrower A incurs a new worst present status in his mortgage No. 1 in April, another worst present status in his mortgage No. 2 in May, borrower A would have the attribute for both April and May. However, borrower A would not have the attribute in June if he does not incur any new worst present status, even though he already has two from the previous two months. Thus, the attribute can be thought of as tracking current negative credit history movements rather than the cumulative and/or historical negative credit histories of the borrowers in the loan portfolio.

Returning to the graph 640, the X-axis depicts the time intervals at which the credit migration module 182 retrieved credit data for this sample portfolio. The Y-axis depicts the percentage of loans in the sample portfolio that have the worst present status attribute. Graph 640 tracks the percentage of loans borrowers who have incurred at least one such worst present status in their open property trades within the last month. As shown in graph 640, the percentage of loans meeting this worst present status attribute increased from 0% to 8% over a period of one year. In one embodiment, the output graph 640 may provide investors of this portfolio the increased transparency that is lacking in the current market and an opportunity to evaluate the risks and make appropriate investment decisions. The output graph 640 can be an index that provides the market a way to properly valuate ABS in an on-going basis. For example, a credit rating agency may downgrade this sample portfolio upon seeing that the percentage of loans with the worst present status has increased to 8%.

Embodiments of the credit migration module 182 (FIG. 6A) may also analyze other credit attributes that may have correlations to default risks and provide output results of tracking these credit attributes. Similar to graph 640, graph 650 in FIG. 6B-2 also tracks monthly changes in the percentage of accounts with an increase of 1 or more in the worst present status, except graph 650 tracks such a status on any open trade line instead or an open real property line. Returning to the example of borrower A, this attribute in FIG. 6B-2 would track, in addition to new worst present status in borrower A's mortgages, such status in other non-real property related accounts in borrower A's file including credit cards, student loans, and auto loans. Again, the graph 650 shows a portfolio with a relatively steady increase in the percentage of worst present status increases and allows investors and other ABS market participants to take appropriate measures to counteract the increased risks.

Graph 660 of FIG. 6B-3 and graph 670 of FIG. 6B-4 plot monthly changes in the percentage of accounts that have real property trades that are delinquent or derogatory increasing by 1 or more. Graph 660 tracks the increase of 30-day delinquencies while graph 670 tracks the increase of 60-day delinquencies. Returning to the example of borrower A, these attributes would track delinquencies within borrower A's credit files. For example, if borrower A is more than 30 days late in his mortgage payment, borrower A would be associated with the attribute tracked in graph 660. If borrower A is more than 60 days late in his mortgage payment, borrower A would be associated with the attribute tracked in graph 670. These attributes in the credit files have strong correlation to risk of loan defaults. Similar to graphs 640 and 650, these graphs show the historical progression of the monthly credit data migrations and may allow investors and market participants to view risk trends and decide on proper courses of action. In other embodiments, the credit migration module 182 may produce other analytical graphs tracking change of status in the tradelines such as degree of delinquency, life events, and so forth.

Triggers

In general, triggers are conditions that, when met, will initiate one or more system actions. Within the context of various embodiments, because each loan is trackable by a unique loan identifier, information on the borrowers can be obtained and correlated back to the individual loans. Thus, investors can set up triggers based on changes to the respective borrowers' credit files. In one embodiment, the trigger notification module 184 accepts as input several triggers that will generate alerts. For example, predefined alerts can be set up to notify investors, underwriters, and/or others, of the changes in underlying asset borrower behavior over time. An example trigger may send an alert if a certain number of borrowers in a loan portfolio have defaulted on their credit cards. The alerts can be sent at any time interval, for example, daily, weekly, monthly, quarterly, and/or in real-time. Depending on the embodiment, alerts may be sent via real-time email, periodic batch emails, real-time or periodic batch database exports. The alerts may be sent to computer servers, desktops, mobile devices, and may be sent via proprietary portal interface software, and so forth.

FIG. 7A shows a process of notification triggers data flow of the trigger notification module 184 (FIG. 1) in one embodiment. At block 710, a number of trigger requirements are defined by, for example, users of the loan tracking and analysis system 100 and sent to the system 100. The trigger requirements may include three primary components: thresholds, frequency of notification, and level of analysis (loan-level or portfolio-level). In other embodiments, the trigger requirements may be based on other attributes of loans, portfolios, and/or other related data. In addition, loan portfolio CUSIP numbers or securities with securitization IDs may also be sent to the loan tracking and analysis system 100 at block 710.

Thresholds are defined boundaries and may include credit score changes, number of new trades, and number of new accounts, and so forth. For portfolio-level triggers, thresholds can include the percentage of loans that must meet the thresholds before notifications are sent. Thresholds may be combined, for example, by Boolean operators. For example, an investor may define a trigger to include a 5% credit score change threshold and a 1 new account threshold for 10% of a portfolio. Thus when borrowers of at least 10% of the loans in the portfolio have both incurred a 5% change in their credit scores and opened a new account, the investor will be notified.

Once the triggers are defined, at block 720, the securitization IDs received in the input at block 710 are matched with the borrower-specific identifiers in the consumer credit files. In one embodiment the borrower-specific identifiers are the credit file IDs of the borrowers. At the pre-defined intervals in accordance with the frequency of notification input at block 710, the tracking and analysis module 150 checks the referenced credit files to see if data associated with the borrowers and/or portfolios still satisfy the trigger thresholds. If so, the trigger notification module 184 will send out notifications. In one embodiment, an output is sent at block 730 to the client users without any personal identifying information. The output may include securitization IDs in the portfolio that meet the trigger thresholds.

FIG. 7B shows four example data sources on which trigger sources may be based, such as new trade and inquiry triggers 740, public record data triggers 750, existing trade data triggers 760, and triggers based other information specific to the borrower 770. Thus, for example, an investor can set up a trigger to send an alert notification when a certain number of loan borrowers in their portfolios have new trades added to their credit files. Similarly, another investor may want to monitor whether a substantial number of judgments or liens from public record sources have been placed in the credit files of the borrowers in a portfolio. Thus, the collection of alert notifications may form a part of a holistic risk profile for a proactive approach to investment management.

Portal Interface

FIG. 8 shows a sample layout of the portal interface 180 (FIG. 5) in accordance with an embodiment. In one embodiment, the tracking and analysis module 150 and/or portal interface 180 may perform analysis on loan portfolios and output the results in a number of graphical formats. The portal interface 180 may be accessible via a web browser or standalone software application, for example. In the embodiment of FIG. 8, the portal interface 180 provides links to a plurality of interfaces, namely, a portfolio management interface 810, a credit summary interface 820, a collateral summary interface 830, a loan management scorecard interface 840, and an investor dashboard interface 850. The credit summary interface 820 may compute and/or show both current and historical credit histories of the individual borrowers, in either individual or aggregate formats. The collateral summary interface 830 may compute and/or show valuation and other data related to the collaterals (e.g. houses, cars) that underlie the loans. The portfolio management interface 810, the loan management scorecard interface 840, and the investor dashboard interface 850 will be described in greater details below.

Portfolio Management

As shown previously in FIG. 5, portal interface 180 can accommodate the display of analytics both at the loan portfolio level and at the loan level. In one embodiment, the portfolio level analytics are shown in the portfolio management interface 810, which provides a benchmark tool interface with trade level information for comparing the health of an ABS portfolio against peers, industry-wide averages, and/or historical performances. Because each loan is identifiable by a unique loan identifier, a variety of credit, financial, and loan data can be correlated to the individual loans. As a result, these data can be analyzed to more accurately reflect the health of the portfolio.

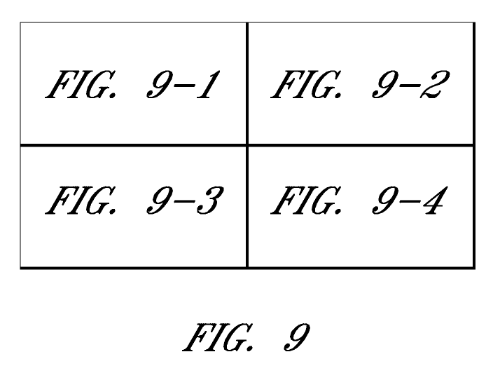

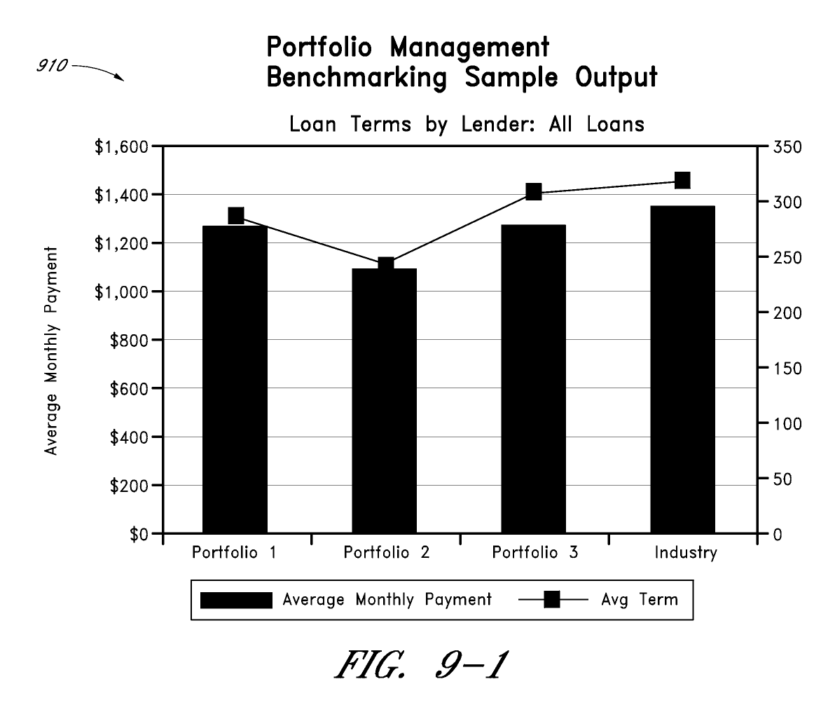

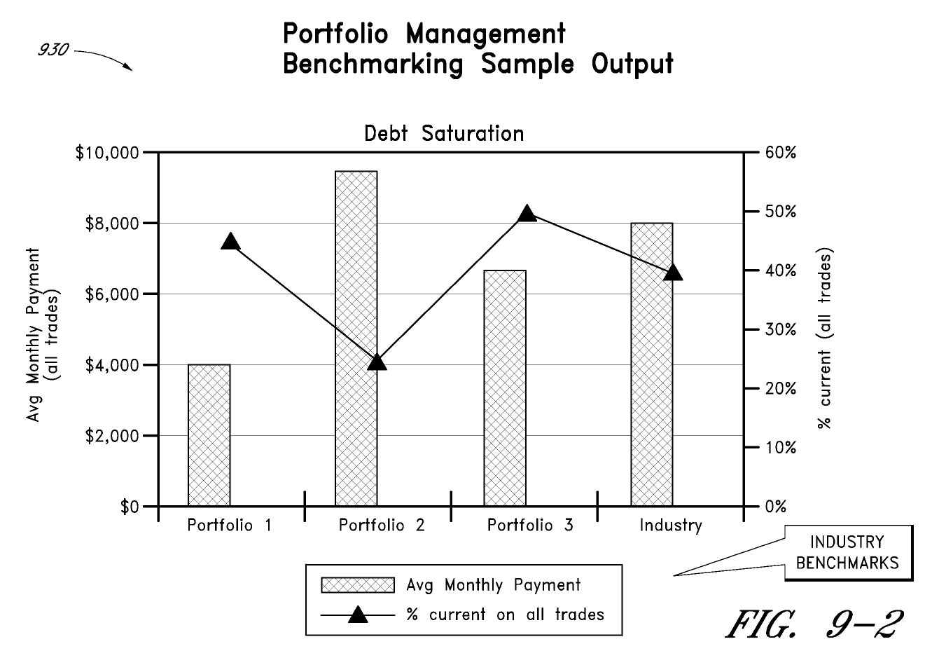

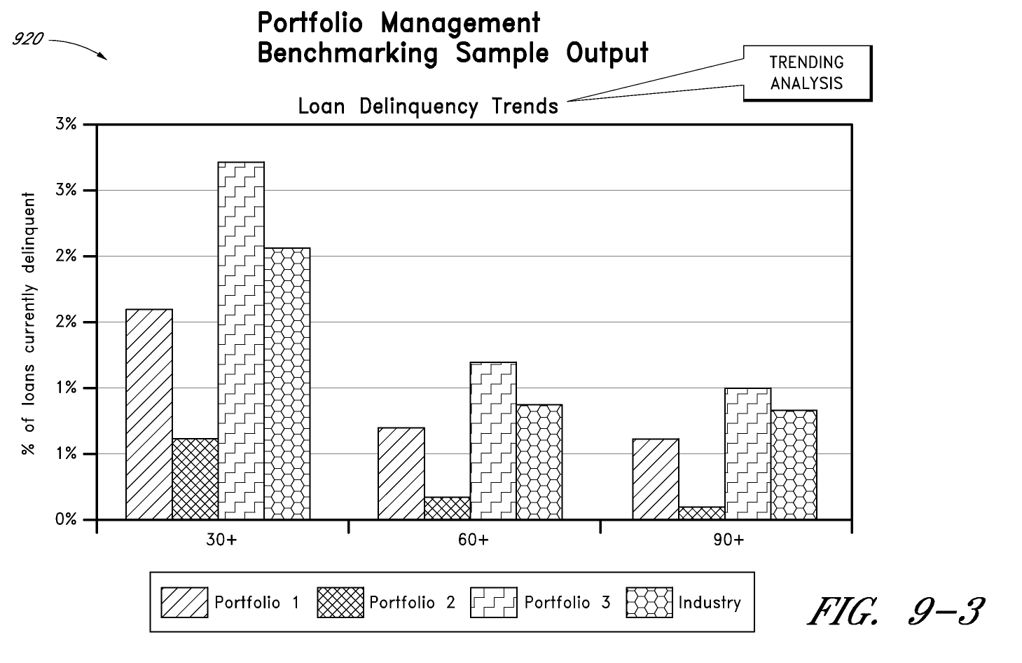

FIG. 9 shows the sample output graphs of the benchmarking tool interface. In this embodiment, sample graph 910 illustrates the loan terms and average monthly payment across several portfolios. Graph 920 is an example of the trending analysis that the benchmarking tool interface may perform in accordance to various embodiments. Because individual loans can be tracked throughout their life cycle, current data can be analyzed and compared to historical trends, industry trends, and projected future performance. Graph 920 shows loan delinquency trends plotted across three sample portfolios and against the industry average. Graph 930 shows the debt saturation level of several portfolios as compared to the industry average. Finally, graph 940 shows the risk distribution across the same three portfolios and the industry average. Depending on the embodiment, additional or fewer graphs may be available, and the information provided in the graphs may be different. For example, other graphs may compare loan portfolios against each other, against peer groups, against an industry average, and/or against a benchmark.

Loan Management

At the loan level, one embodiment of the loan tracking and analysis module 150 (FIG. 1) generates the loan management scorecard user interface 840, which provides transparency to the underlying assets of the ABS. The scorecard interface 840 may include reporting functionality to create customized charts and graphs and loan level detail drill down capabilities. The loan level detail may provide access to several key pieces of information, such as (1) Credit behavioral characteristics—historical, current, and projected; (2) Payment behavior; (3) Number of open accounts and balance; (4) Public Records; (5) Predictive behavioral scores for default and prepayment; (6) Refreshed Loan to Value Ratio; (7) Fraud score; and/or (8) Collateral Information.

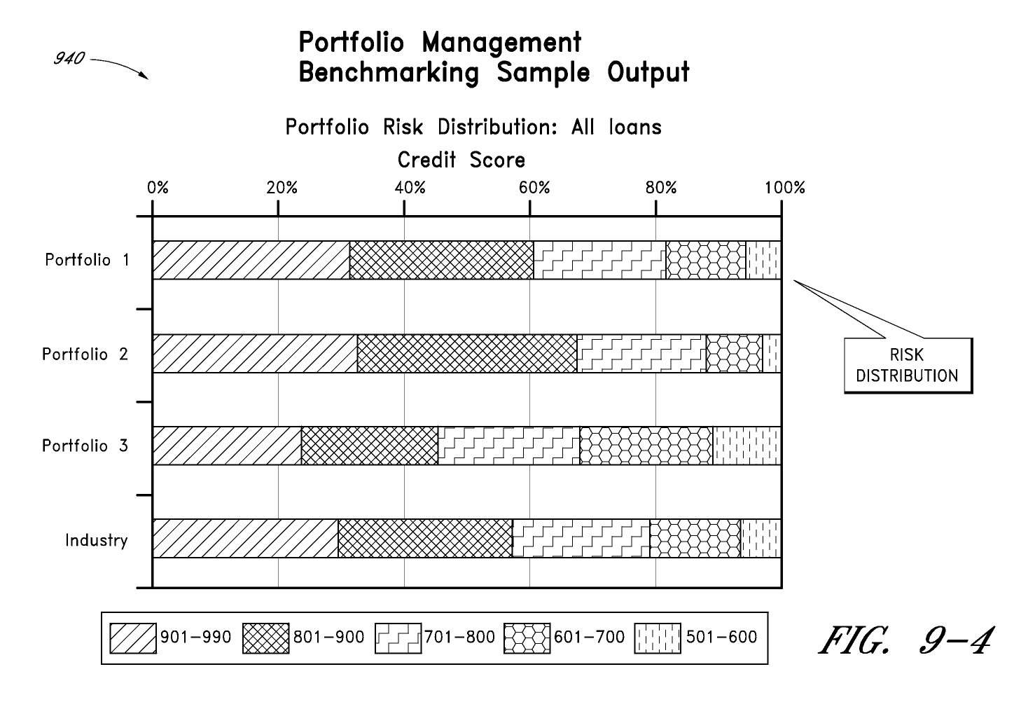

FIG. 10 provides a sample loan-level interface 1000. As shown, the sample loan-level interface 1000 provides part or all of the following information for each loan: origination date, original loan amount, current balance, loan type, original amortization term, remaining amortization term, original FICO, delinquency status, property type, ownership, and LTV. In addition, because data records for each loan are appended with a unique loan identifier, the loan-level interface 1000 may provide information pulled from other resources and correlated with the particular loan. For example, the loan-level view 1000 may further include account status information 1010 retrieved from the borrower's credit files, including the borrower's installment accounts, revolving accounts, auto loans/collateral, and student loans. Furthermore, the loan-level interface 1000 may additionally include information regarding public records and collection tradelines 1020 in the borrower's credit histories. In one embodiment, the loan-level interface 1000 may include a variety of updated scores 1030, including an updated credit score from a credit bureau, a refreshed FICO score by Fair Isaac, and/or a refreshed LTV, for example. Other computed scores 1040 including a default score, a bankruptcy score, a fraud score and/or a prepayment score, for example, may also be available.

Investment Dashboard

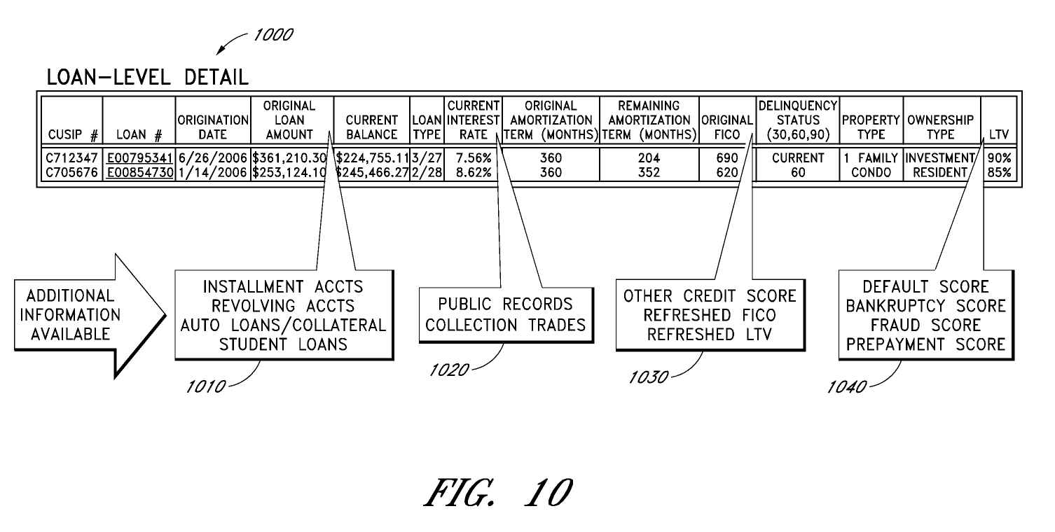

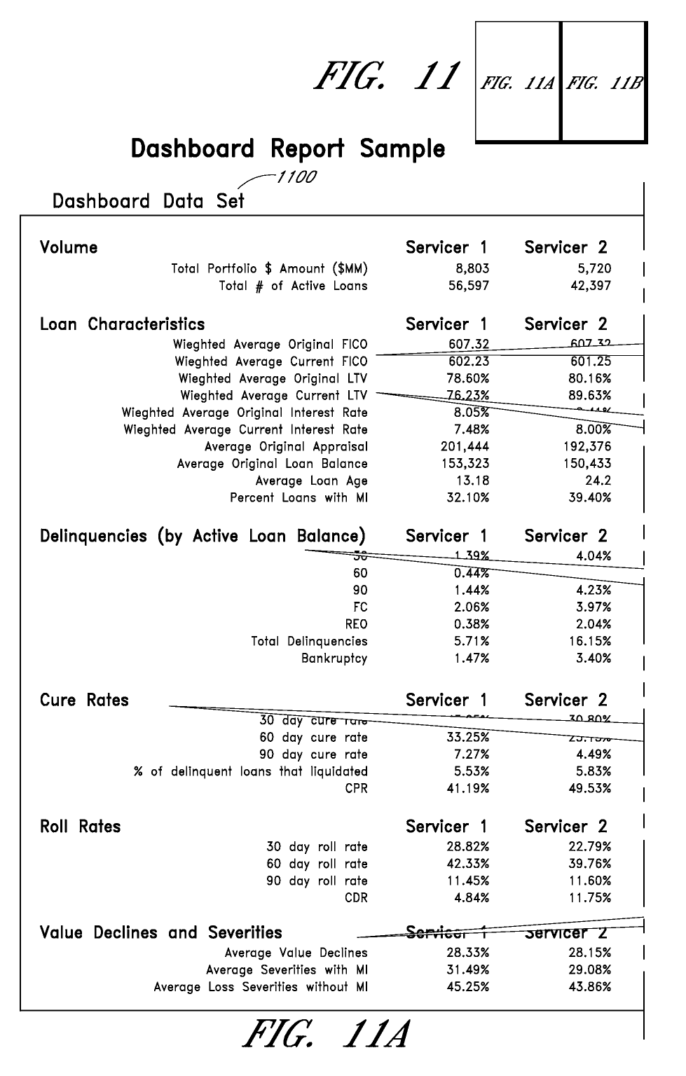

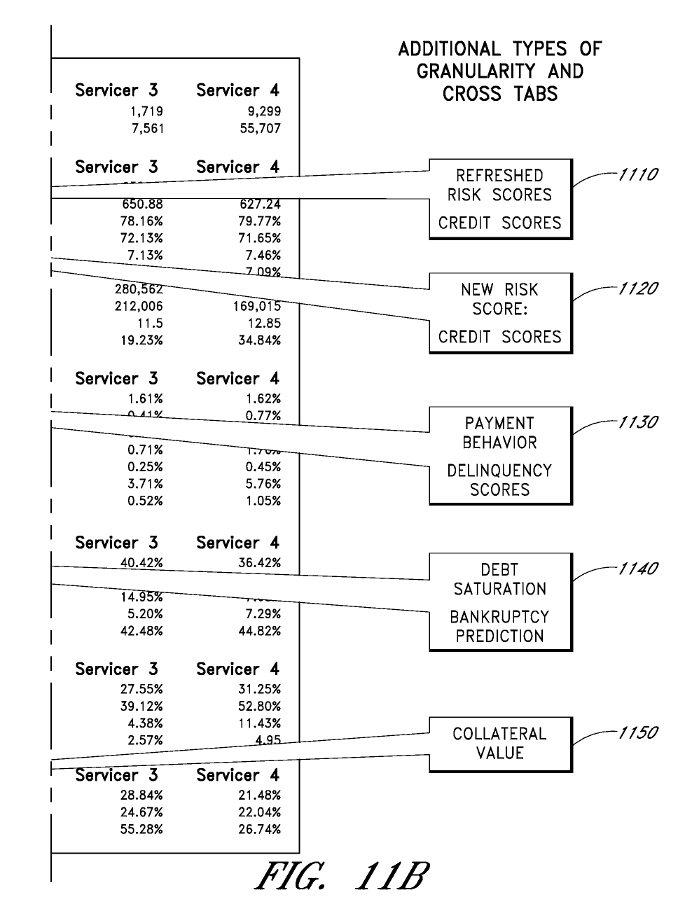

FIG. 11 shows a sample dashboard user interface, referred to herein as an investment dashboard 1100, in accordance with one embodiment. The dashboard 1100 offers investors (or other users of the system) a comprehensive view of the analytics of their portfolios over a given time period. As shown, the sample dashboard 1100 includes portfolio statistics such as volume, loan characteristics, delinquencies, cure rates, roll rates, and value declines and severities. In addition, the dashboard 1100 may provide refreshed risk scores, for example, credit scores and a new risk score from a credit bureau. The credit scores can be, for example, FICO scores by Fair Isaac, VantageScore by Experian, or other credit scores. The scores may be used to categorize loans into different risk segments. The dashboard 1100 may additionally provides payment behavior information, delinquency scores, debt saturation information, bankruptcy prediction, and/or collateral value information. The dashboard 1100 reports can be manipulated for time period analysis. In addition, the dashboard 1100 may include cross tab and additional drill down capabilities. For example, a 60-day delinquencies cross-tab may include a link to a page that shows detailed data related to loans that fall within the 60-day delinquent category. In one embodiment, the link may be accessed by clicking on the corresponding row of data display, for example, the label “60” under the “Delinquencies (by Active Loan Balance)” section. The linked cross-tab page may provide, for example, credit scores of borrowers whose loans are 60-day delinquent. In another example, the dashboard 1100 further provides a drill-down capacity that may allow users to further examine detailed loan-level data behind the numbers shown in the dashboard 1100. For example, investors can drill down to loan-level information for the loans that are 60-day delinquent from the dashboard 1100.

Map-Based Portfolio Analysis

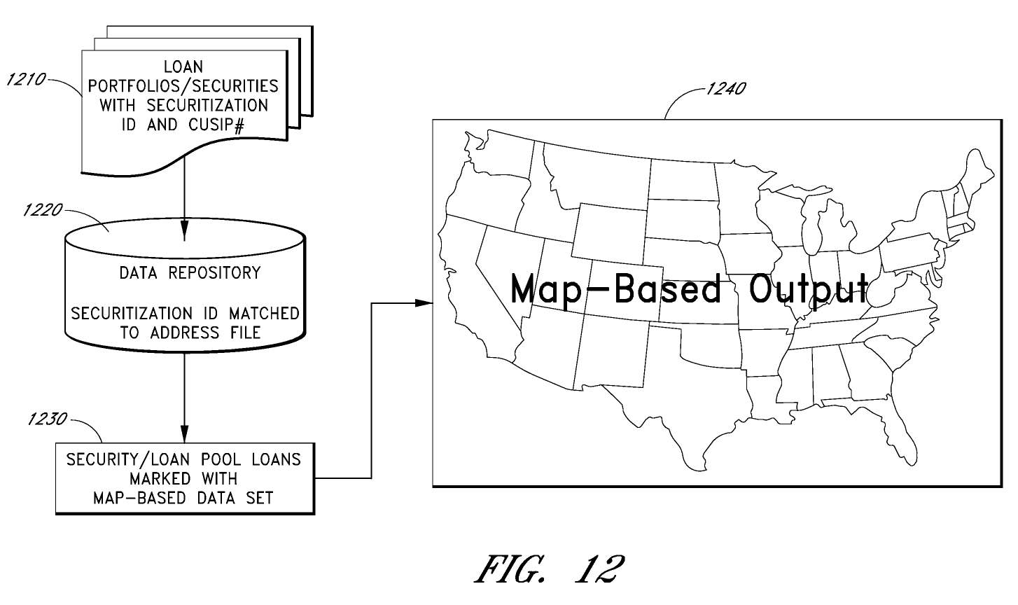

FIG. 12 shows a map-based portfolio analysis in accordance with one embodiment. As shown, at block 1210 loan portfolios and ABS that have been associated with SIDs and/or CUSIPs are input into the loan tracking and analysis system 100. At block 1220, addresses of the borrowers and/or collaterals are then located by cross-reference in the repository 172, for example, by the method shown in FIG. 4C. At block 1230, the addresses are then joined with a location based data source. In the example shown, the addresses are joined with the ZIP+4 (9-digit ZIP) data source, which summarizes the credit data for populations in the United States. The credit data may include credit data, financial data, summarized credit statistics, and/or collateral information. Other data sources such as 3-digit ZIP, 5-digit ZIP, and 7-digit ZIP can be used as well. The results are provided in a map interface 1240, which displays the geographic allocation of the collaterals or borrowers within a portfolio, along with a color coded-scheme for representing the credit summary used. The map-based view offers investors (or other users of the system) a geographic view of the analytics of their portfolios.

### CONCLUSION

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A computerized system for analyzing loans involved in asset-backed securities, comprising:
a credit migration database that stores consumer credit and financial data;
a data repository that assigns a securitization ID to a loan and associates the securitization ID to a credit data record in the credit migration database that is associated with a borrower of the loan;
a tracking and analysis module that, upon request, analyzes one or more loans by using the respective loan securitization IDs to:
retrieve the credit data records of the borrowers of the loans from the credit migration database after the loans have been securitized as asset-backed securities;
calculate a loan default risk based on payment records and account tradeline information within the credit data records that are associated with the borrowers; and
store the loan default risk in the data repository; and
a portal interface through which authorized users can access at least the loan default risk stored in the data repository, wherein the portal interface is configured to provide data to the authorized users via one or more network connections.

2. The computerized system of claim 1, further comprising a trigger notification module that:
causes the tracking and analysis module to be executed based on a pre-determined frequency;
compares the loan default risk to a set of pre-defined threshold conditions; and
sends notifications when at least one of the threshold conditions is met.

3. The computerized system of claim 2, wherein the frequency and the threshold conditions are defined by a user of the system.

4. The computerized system of claim 1 wherein the credit data record is a unique PIN-based consumer data record.

5. The computerized system of claim 1 wherein the loan default risk is based on historical loan performance and borrower default risk stored in the data repository.

6. The computerized system of claim 5 wherein the loan default risk is based on collateral information stored in the data repository.

7. The computerized system of claim 6 wherein the collateral information relates to a real property.

8. The computerized system of claim 6 wherein the collateral information relates to an automobile.

9. The computerized system of claim 2 wherein the default risk is based on borrower credit behavior.

10. The computerized system of claim 1 wherein the tracking and analysis module retrieves the credit data records stripped of personal identifying information.

11. A method of analyzing performance of loans and borrower credit profiles involved in asset-backed securities, comprising:
assigning a unique loan identifier to each of a plurality of loans;
associating one or more borrower credit data records with each of the loan identifiers;
after the loans have been issued and securitized as asset-backed securities, using the loan identifiers to retrieve the credit data records of the respective borrowers of the plurality of loans; and
analyzing the loans based on the retrieved credit data records of the borrowers.

12. The method of claim 11, wherein the analyzing further comprises:
retrieving the credit data records of the borrowers from a credit database, wherein the credit data records further include a plurality of credit data attributes.

13. The method of claim 12, further comprising:
performing the retrieving periodically at specified time intervals;
recording the retrieved credit data records;
comparing the credit data records retrieved from different time periods to determine a trend in the collective performance of the plurality of loans.

14. The method of claim 13 wherein the trend includes one of payment behavioral changes, credit behavioral changes, and projection of future performances.

15. The method of claim 13, further comprising:
outputting information indicating the trend in a graph format.

16. The method of claim 13, wherein the comparing determines the percentage of the plurality of loans having a negative status in a tradeline.

17. The method of claim 16, wherein the tradeline is a real property tradeline.

18. The method of claim 13, wherein the comparing determines the percentage of the plurality of loans having a delinquent status in a tradeline.

19. The method of claim 18, wherein the tradeline is a real property tradeline.

20. The method of claim 11 wherein the analyzing further comprises:
receiving a plurality of conditions;
examining the credit data records to determine whether the plurality of conditions are met; and
sending notifications when the credit data records meet at least one of the plurality of conditions.

21. The method of claim 20 wherein the notifications are sent in real-time.

22. The method of claim 21 wherein the conditions comprise the presence of one or more current negative or positive change items in the credit data records.

23. A computerized system for analyzing loans involved in asset-backed securities, comprising:
a data repository that assigns a unique loan identifier to each of a plurality of loans and associates each loan identifier to one or more credit data records of the respective borrowers of the loans; and
a tracking and analysis module that, upon request, analyzes a first plurality of the loans that have been combined into an asset-backed security, wherein the tracking and analysis module uses the loan identifiers associated with the first plurality of loans in order to:
retrieve credit data records of the borrowers associated with the first plurality of loans after the loans have been securitized as asset-backed securities,
analyze the performance of the first plurality of loans based on the retrieved credit data records, and
provide the performance analysis to one or more entities that are authorized to receive the performance analysis.

24. The computerized system of claim 23, wherein the entities comprise one or more of loan issuers, loan underwriters, loan servicers, and loan investors.

25. The computerized system of claim 24 wherein the data repository system stores CUSIP numbers assigned by the loan underwriters and associates the unique loan identifiers to the CUSIP numbers.

26. The computerized system of claim 23, further comprising:
a portal interface through which the performance analysis can be accessed, the portal interface further comprising:
a loan-level management interface module through which updated credit data records associated with a loan of the plurality of loans is displayed.

27. The computerized system of claim 25 wherein the updated credit data records include one or more of updated tradelines, updated public records, updated credit scores, and loan securitization status information.

28. The computerized system of claim 23, further comprising:
a portal interface through which the performance analysis can be accessed, the portal interface further comprising:
a loan portfolio management interface displaying updated credit data records associated with the first plurality of loans.

29. The computerized system of claim 28 wherein the tracking and analysis module aggregates the credit data records associated with the first plurality of loans and outputs aggregated results to the loan portfolio management interface.

30. The computerized system of claim 29 wherein the aggregated results comprise one or more of weighted average credit scores, weighted average risk scores, delinquencies rates, and other credit behavior characteristics.

31. The computerized system of claim 28 wherein the loan portfolio management interface displays aggregated results of a plurality of loan portfolios, wherein the performance of the loan portfolios can be compared against each other, against peer groups, against an industry average, or against a benchmark.

32. The computerized system of claim 23 wherein the tracking and analysis module:
retrieves the credit data records of the borrowers associated with the first plurality of loans periodically at specified time intervals, wherein the credit data records further include a plurality of credit data attributes;
records the retrieved credit data records in the data repository; and
compares the credit data records retrieved from different time periods to determine a trend in the collective performance of the first plurality of loans.

33. The computerized system of claim 32 wherein the plurality of credit data attributes comprise collateral valuation attributes.

34. The computerized system of claim 32, wherein the tracking and analysis module outputs the comparison of credit data records retrieved from different time periods in a graph format.

35. The computerized system of claim 32, wherein the tracking and analysis module determines the percentage of the first plurality of loans with a credit data attribute indicating a negative status in a tradeline.

36. The computerized system of claim 35 wherein the tradeline is a real property tradeline.

37. The computerized system of claim 32 wherein the tracking and analysis module determines the percentage of the first plurality of loans with a credit data attribute indicating a change of status in a tradeline.

38. The computerized system of claim 37 wherein the tradeline is a real property tradeline.

39. The computerized system of claim 23 wherein the tracking and analysis module:
receives a plurality of conditions;
examines the credit data records to determine whether the plurality of conditions are met; and
sends notifications when the credit data records meet at least one of the plurality of conditions.

40. The computer system of claim 23, further comprising a portal interface through which the results can be accessed, the portal interface further comprising:
a map-based output through which updated credit data records associated with the plurality of loans are displayed in a map-based format.

41. The computer system of claim 40 wherein the map-based output is based on one of 3-digit ZIP data, 5-digit ZIP data, 7-digit ZIP data, and 9-digit ZIP data.

42. The computer system of claim 40 wherein the credit data records comprise summarized credit statistics or collateral associated with the plurality of loans.

43. A computer program product comprising a computer usable medium having control logic stored therein for causing a computer to track and analyze loans involved in asset-backed securities, comprising:
a first computer readable program code for causing the computer to assign a unique loan identifier to each of a plurality of loans;
a second computer readable program code for causing the computer to associate one or more borrower credit data records with each of the loan identifiers;
a third computer readable program code for causing the computer to use the loan identifiers to retrieve the credit data records of the respective borrowers of the plurality of loans after the loans have been issued and securitized as asset-backed securities; and
a fourth computer readable program code for causing the computer to analyze the loans based on the retrieved credit data records of the borrowers.

44. The computer program product of claim 43, further comprising:
a fifth computer readable program code for causing the computer to retrieve the credit data records of the borrowers from a credit database, wherein the credit data records further include a plurality of credit data attributes.

45. The computer program product of claim 44, further comprising:
a sixth computer readable program code for causing the computer to execute the fifth computer readable program code means for causing the computer to retrieve periodically at specified time intervals;
a seventh computer readable program code for causing the computer to record the retrieved credit data records;
an eighth computer readable program code for causing the computer to compare the credit data records retrieved from different time periods to determine a trend in the collective performance of the plurality of loans.

46. The computer program product of claim 45, further comprising:
a ninth computer readable program code for causing the computer to output information indicating the trend in a graph format.

47. The computer program product of claim 46, further comprising:
a tenth computer readable program code for causing the computer to store CUSIP numbers received from one or more loan underwriters and associate loan identifiers to the CUSIP numbers.

48. A computerized system for analyzing loans involved in asset-backed securities, comprising:
a credit migration database that stores consumer credit and financial data;
a data repository that assigns a securitization ID to a loan and associates the securitization ID to a credit data record in the credit migration database that is associated with a borrower of the loan;
a tracking and analysis module that, upon request, analyzes one or more loans by using the respective loan securitization IDs to:
retrieve the credit data records of the borrowers of the loans from the credit migration database after the loans have been securitized as asset-backed securities;
calculate a loan characteristic based on payment records and account tradeline information within the credit data records that are associated with the borrowers; and
store the loan characteristic in the data repository; and
a portal interface through which authorized users can access at least the loan characteristic stored in the data repository, wherein the portal interface is configured to provide data to the authorized users via one or more network connections.

49. The computerized system of claim 48 wherein the loan characteristic is a prepayment risk.

50. The computerized system of claim 48 wherein the loan characteristic is an average interest rate.
